(19) United States
(12) Patent Application Publication
(10) Pub. No.: US 2014/0286050 A1
(43) Pub. Date: Sep. 25, 2014

(54) BACKLIGHT MODULE

(71) Applicant: HON HAI PRECISION INDUSTRY CO., LTD., New Taipei (TW)

(72) Inventors: LI-YING WANG HE, Tu-Cheng (TW); PO-CHOU CHEN, Tu-Cheng (TW)

(73) Assignee: HON HAI PRECISION INDUSTRY CO., LTD., New Taipei (TW)

(21) Appl. No.: 14/203,580

(22) Filed: Mar. 11, 2014

(30) Foreign Application Priority Data
Mar. 21, 2013 (TW) 102110000

(51) Int. Cl. F21V 8/00

(52) U.S. Cl. CPC G02B 6/0091; G02B 6/0031; G02B 6/0035
USPC 362/609; 362/613

(57) ABSTRACT

A backlight module comprises a light guide plate, a plurality of light guide portions, and a plurality of light sources. Each light guide portion is wedge-shaped. Each light guide portion comprises a first side surface and a second side surface opposite to the first side surface. The second side surface is in contact with the light guide plate. Along a direction perpendicular to the light guide plate, a thickness of the first side surface is greater than a thickness of the second side surface. A receiving groove is defined on the first side surface. Each light source is received in a corresponding one of the receiving grooves.

### BACKGROUND

1. Technical Field

The present disclosure relates to a backlight module.

2. Description of Related Art

A side-type backlight module includes a light guide plate and a number of light sources positioned on a light incident side of the light guide plate. Although the thickness of the light guide plate is becoming smaller, it is very difficult to reduce the thickness of the light sources. Therefore, the optically coupling efficiency between the light guide plate and the light sources is low, the light rays entering the light guide plate are reduced, and the brightness of the backlight module is low.

Therefore, it is desirable to provide a backlight module that can overcome the above-mentioned limitations.

### BRIEF DESCRIPTION OF THE DRAWINGS

Many aspects of the embodiments should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a backlight module, according to a first embodiment.

FIG. 2 is a side view of the backlight module of FIG. 1.

FIG. 3 is a partial, enlarged schematic view of the backlight module of FIG. 1.

FIG. 4 is a partial, enlarged schematic view of a backlight module according to a second embodiment.

FIG. 5 is partial, enlarged schematic view of a backlight module according to a third embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

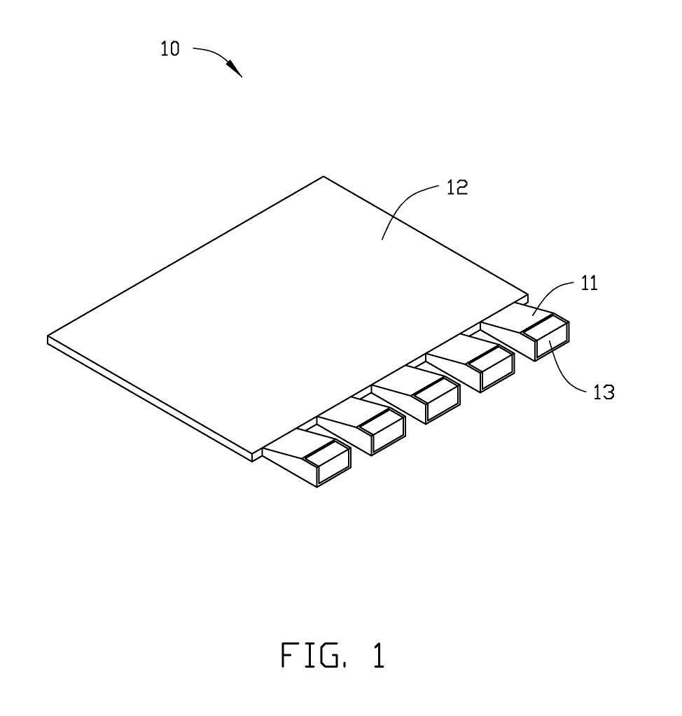

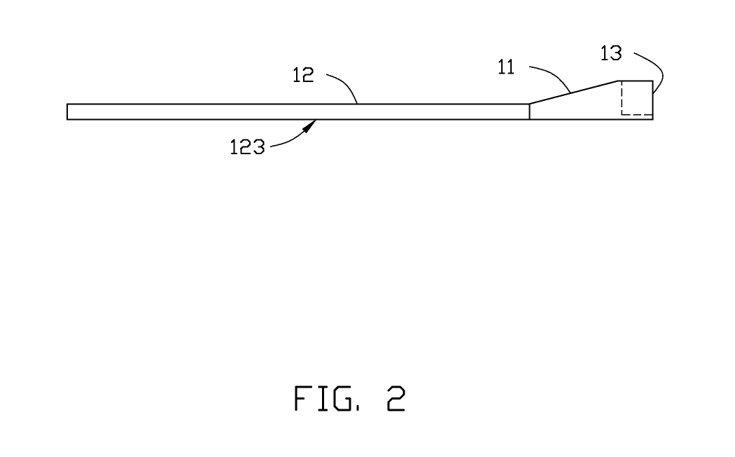

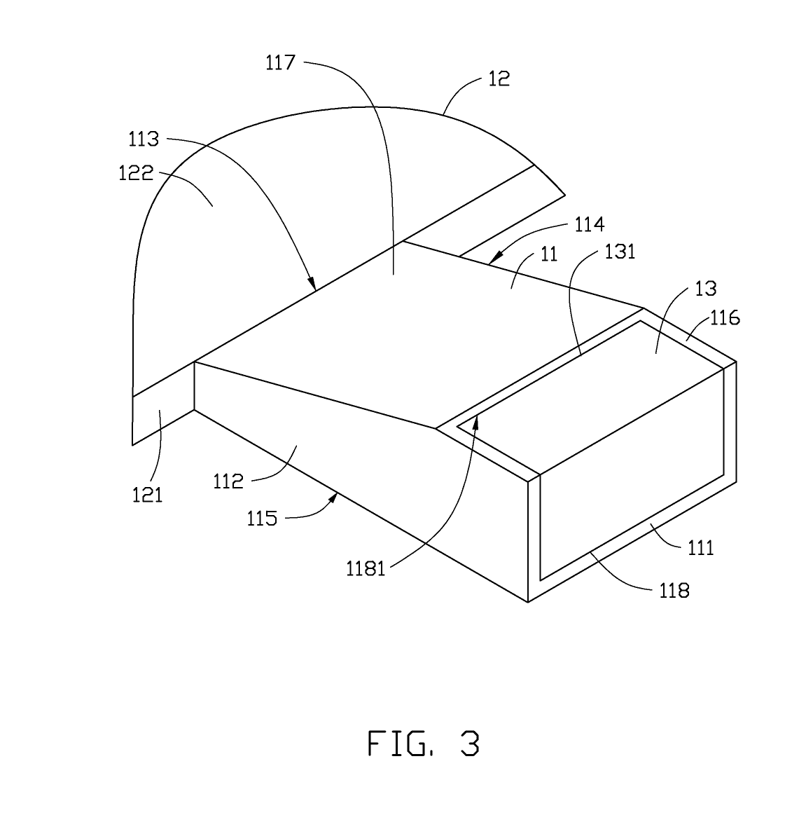

FIGS. 1-3 illustrate a backlight module 10 in accordance with a first embodiment. The backlight module 10 includes a number of light guide portions 11, a light guide plate 12, and a number of light sources 13. The structures of the light guide portions 11 are the same, and are spatially corresponding to the light sources 13.

The light guide plate 12 is made of transparent material, such as transparent resin. The light guide plate 12 includes a light incident surface 121, a light emitting surface 122 perpendicularly connected to the light incident surface 121, and a reflective surface 123 parallel with and opposite to the light emitting surface 122.

The light guide portions 11 are all fixed on the light incident surface 121. The light guide portions 12 are all made of transparent material. Each light guide portion 12 is wedge-shaped. Each light guide portion 12 includes a first side surface 111, a third side surface 112, a second side surface 113 opposite to the first side surface 111, a fourth side surface 114, a bottom surface 115, a top surface 116 and a connecting surface 117. The first side surface 111 faces and is parallel with the second side surface 113. The third side surface 112 faces and is parallel with the fourth side surface 114. The third side surface 112 is perpendicularly connected to the first side surface 111 and the second side surface 113. The fourth side surface 114 is perpendicularly connected to the first side surface 111 and the second side surface 113. The second side surface 113 is in contact with the light incident surface 121. The bottom surface 115 is perpendicularly connected to the first side surface 111, the third side surface 112, the second side surface 113, and the fourth side surface 114. The bottom surface 115 is substantially coplanar with the reflective surface 123. The top surface 116 faces and is parallel with the bottom surface 115. The top surface 116 is perpendicularly connected to the first side surface 111, the third side surface 112, and the fourth side surface 114. The connecting surface 117 is connected between the top surface 116 and the second side surface 113, and is perpendicularly connected to the third side surface 112 and the fourth side surface 114. Therefore, a gradient angle is formed between the connecting surface 117 and the bottom surface 115. The thickness of the second side surface 113 is equal to or less than that of the light incident surface 121 along the direction perpendicular to the light emitting surface 122. The thickness of the first side surface 111 is larger than that of the second side surface 113 along the direction perpendicular to the light emitting surface 122.

The first side surface 111 defines a receiving groove 118 extending through the top surface 116. The receiving groove 118 includes a side wall 1181 parallel with the light incident surface 121. Each light source 13 is received in a corresponding one of the receiving grooves 118.

The light source 13 includes an irradiance surface 131 in contact with the side wall 1181. A thickness of the irradiance surface 131 is larger than that of the light incident surface 121 and that of the second side surface 113 along the direction perpendicular to the light emitting surface 122. The thickness of the irradiance surface 131 is equal to or less than that of the first side surface 111 along the direction perpendicular to the light emitting surface 122. Thus, light emitted from the irradiance surface 131 can substantially enter into the light guide portion 11, and then enter into the light guide plate 12 through the second side surface 113 and the light incident surface 121.

In other embodiments, the shape of the light guide portion 11 can be other shapes. It is needed that the thickness of the second side surface 113 of the light guide portion 11 is equal to or less than that of the light incident surface 121 of the light guide plate 12 and the light guide portion 11 is big enough to receive the light source 13.

In other embodiments, the first side surface 111, the third side surface 112, the fourth side surface 114, the bottom surface 115, the top surface 116 and the connecting surface 117 can be coated by reflective films, or form a plurality of optical microstructures to internally reflect the light rays in the light guide portion 11, and thus the light rays can be transmitted towards the light guide plate 12.

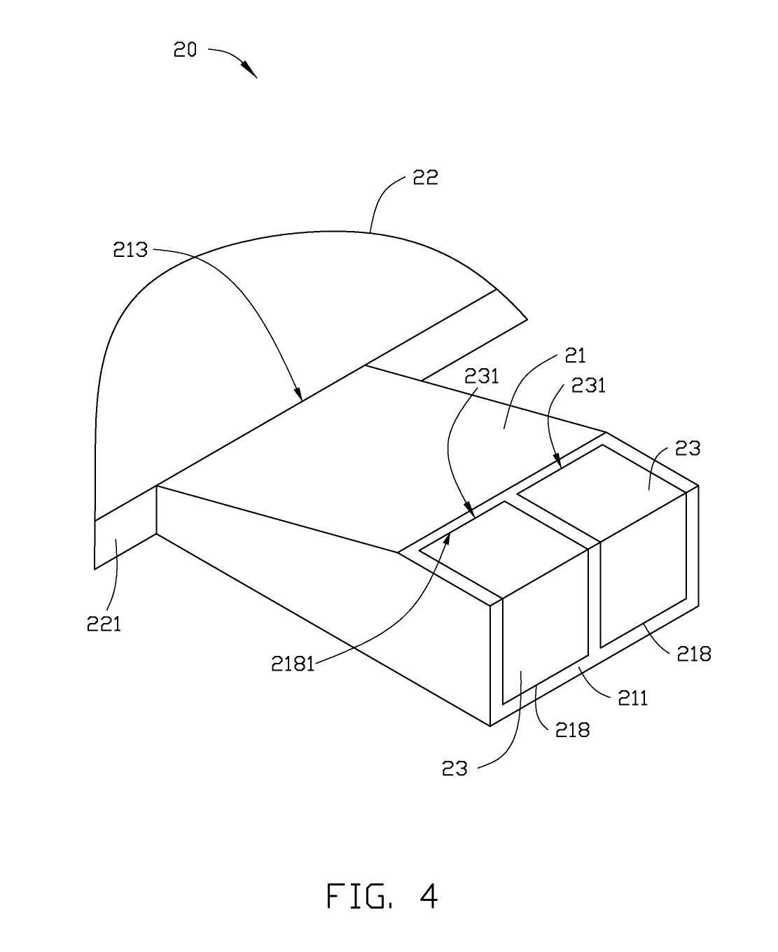

FIG. 4 shows a backlight module 20 according to a second embodiment. The backlight module 20 is similar to the backlight module 10. However, a light guide portion 21 defines a plurality of receiving grooves 218. The number of the light sources 23 is more than that of the light guide portions 21 but equal to that of the receiving grooves 218. Each light source 23 is received in a corresponding one of the receiving grooves 218.

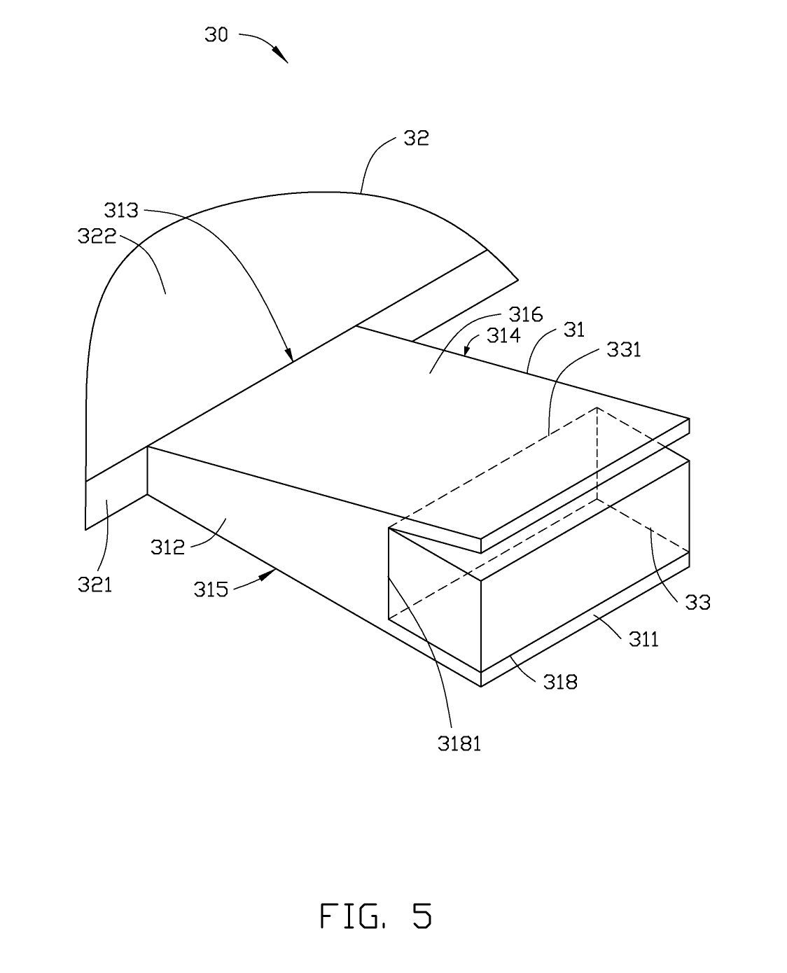

FIG. 5 shows a backlight module 30 according to a third embodiment. The backlight module 30 is similar to the backlight module 10. However, a connecting surface 316 of a light guide portion 31 facing a bottom surface 315 is connected between a first side surface 311 and the second side surface 313 of the light guide portion 31. Therefore, a gradient angle is formed between the connecting surface 316 and the bottom surface 315. A thickness of the first side surface 311 is larger than that of the second side surface 313 along the direction perpendicular to the light emitting surface 322.

The first side surface 311 defines a receiving groove 318 extending through a third side surface 312 and a fourth side surface 314. The receiving groove 318 has a side wall 3181 parallel with a light incident surface 321 of a light guide plate 32 and a second side surface 313 of the light guide portion 31. Each light source 33 is received in a corresponding one of the receiving grooves 318.

The light source 33 includes an irradiance surface 331 in contact with the side wall 3181. A thickness of the irradiance surface 331 is larger than that of a light incident surface 321 of the light guide plate 32 and that of the second side surface 113 of the light guide portion 31 along the direction perpendicular to the light emitting surface 322 of the light guide portion 31. The thickness of the irradiance surface 331 is equal to or less than that of the side wall 3181 along the direction perpendicular to the light emitting surface 322.

By employing the backlight module 10, 20, 30, the light emitted from the light sources 13, 23, 33 can substantially enter into the light guide portions 11, 21, 31, and then substantially enter into the light guide plate 12, 22, 32, which can improve the optical coupling efficiency of the light guide portions 11, 21, 31 and the light guide plate 12, 22, 32, when the thickness of the light sources 13, 23, 33 remains unchanged.

It will be understood that the above particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A backlight module, comprising:
a light guide plate, comprising a light incident surface and a light emitting surface perpendicularly connected to the light incident surface;
a plurality of light guide portions fixed on the light incident surface, each light guide portion comprising:
a first side surface;
a second side surface opposite to the first side surface, the second side surface being in contact with the light incident surface; and
a receiving groove being defined on the first side surface; and
a plurality of light sources, each light source being received in a corresponding one of the receiving grooves, and comprising an irradiance surface facing the light guide plate;
wherein along a direction perpendicular to the light emitting surface, a thickness of the irradiance surface is greater than a thickness of the light incident surface, and the thickness of the second side surface is equal to or less than a thickness of the light incident surface.

2. The backlight module of claim 1, wherein the light guide portions are all made of transparent material.

3. The backlight module of claim 1, wherein each light guide portion further comprises a bottom surface, a top surface, and a connecting surface, the bottom surface being perpendicularly connected to the first side surface and the second side surface, the top surface facing and parallel with the bottom surface, the top surface being perpendicularly connected to the first side surface, the connecting surface being connected between the top surface and the second side surface, a gradient angle forming between the connecting surface and the bottom surface, the receiving groove extending through the top surface.

4. The backlight module of claim 3, wherein the light guide plate further comprises a reflective surface parallel with and opposite to the light emitting surface, the bottom surface being substantially coplanar with the reflective surface.

5. The backlight module of claim 3, wherein the bottom surface, the top surface, and the connecting surface are coated by reflective films to reflect light rays in the light guide portion.

6. The backlight module of claim 3, wherein a plurality of optical microstructures is formed on the bottom surface, the top surface, and the connecting surface to reflect light rays in the light guide portion.

7. The backlight module of claim 1, wherein each light guide portion further comprises a bottom surface and a connecting surface, the bottom surface being perpendicularly connected to the first side surface and the second side surface, the connecting surface facing the bottom surface, the connecting surface being connected between the first surface and the second side surface, a gradient angle forming between the connecting surface and the bottom surface.

8. The backlight module of claim 7, wherein the light guide plate further comprises a reflective surface parallel with and opposite to the light emitting surface, the bottom surface being substantially coplanar with the reflective surface.

9. The backlight module of claim 7, wherein the bottom surface and the connecting surface are coated by reflective films to reflect light rays in the light guide portion.

10. The backlight module of claim 7, wherein a plurality of optical microstructures is formed on the bottom surface and the connecting surface to reflect light rays in the light guide portion.

11. The backlight module of claim 7, wherein each light guide portion further comprises a third side surface and a fourth side surface face to the third side surface, the third side surface and the fourth side surface being connected between the first side surface and the second side surface, the receiving groove extending through the third side surface and the fourth side surface.

12. The backlight module of claim 11, wherein the third side surface and the fourth side surface are coated by reflective films to reflect light rays in the light guide portion.

13. The backlight module of claim 11, wherein a plurality of optical microstructures is formed on the third side surface and the fourth side surface to reflect light rays in the light guide portion.

14. The backlight module of claim 1, wherein along a direction perpendicular to the light emitting surface, the thickness of the second side surface is less than a thickness of the first side surface.

15. The backlight module of claim 1, wherein the receiving groove includes a side wall parallel with the light incident surface, the irradiance surface facing to the side wall, along a direction perpendicular to the light emitting surface, the thickness of the irradiance surface is equal to or less than a thickness of the side wall.

16. The backlight module of claim 15, wherein the irradiance surface is in contact with the side wall.
